(19) United States
(12) Patent Application Publication
(10) Pub. No.: US 2026/0281501 A1
(43) Pub. Date: Sep. 17, 2026

(54) METHOD AND SYSTEM FOR PROVIDING AND OUTPUTTING MEDIA CONTENT FOR A USER OF A VEHICLE

(71) Applicant: MERCEDES-BENZ GROUP AG, Stuttgart (DE)

(72) Inventors: Christian BOOTZ, Böblingen (DE); Manuel KECK, Sonnenbühl (DE)

(21) Appl. No.: 19/564,352

(22) Filed: Mar. 12, 2026

(30) Foreign Application Priority Data
Mar. 13, 2025 (DE) 10 2025 109 576.0

(51) Int. Cl. H04N 21/466; H04N 21/414; H04N 21/442

(52) U.S. Cl. CPC H04N 21/4667; H04N 21/41422; H04N 21/44218

(57) ABSTRACT

Media content is selected to adjust a user's energy state. Measured variables are recorded to determine a current energy state of the user and a target energy state for the user is specified. Media content provided for the user in the past by media sources is identified. A language model is used to determine content from media content that can be provided by the relevant media source. The language model determines, based on the current energy state of the user, the target energy state, and the media content provided for the user in the past, the media content in such a way that, when output in the vehicle, the media content is used to change the current energy state of the user to the target energy state. one of the determined pieces of media content is retrieved from the assigned media source and output in the vehicle.

### CROSS-REFERENCE TO RELATED APPLICATIONS

This application claims priority under 35 U.S.C. § 119 to German Patent Application DE 10 2025 109 576.0, filed on Mar. 13, 2025, the entire content of which is herein expressly incorporated by reference.

### BACKGROUND AND SUMMARY OF THE INVENTION

Exemplary embodiments of the invention relate to a method and a system for providing and outputting media content, in particular music or videos or films, for a user (driver, passenger) of a vehicle. Furthermore, the invention relates to a computer system, a computer program product, a digital storage medium and a computer program.

Exemplary embodiments of the invention are directed to providing vehicle users (driver, passengers) with a selection of media content INH customized to their current energy or emotional state.

A first aspect of the invention relates to a method for providing and outputting media content INH for a user of a vehicle, having the steps:
recording measured variables MGₘ(t) for determining a current energy state EZ(t) of the user, with t:=time and m=1, 2, . . . , M and M≥1;
specifying a target energy state EZ_{SOLL} for the user;
determining the media content INH_{ALT}(Qᵢ) provided for the user in the past by one or more media sources Qᵢ, with i=1, 2, . . . , I and I≥1;
determining, by means of a language model LM, media content INH*(Qᵢ) from media content INH(Qᵢ) that can be provided by the relevant media source Qᵢ, wherein the language model LM determines, based on the current energy state EZ(t) of the user, the target energy state EZ_{SOLL} and the media content INH_{ALT}(Qᵢ) provided for the user in the past, the media content INH*(Qᵢ) in such a way that, when output in the vehicle, the media content INH*(Qᵢ) is used (is suitable) to change the current energy state EZ(t) of the user to the target energy state EZ_{SOLL};
retrieving at least one of the determined pieces of media content INH*(Qᵢ) from the assigned media source Qᵢ; and
outputting the at least one retrieved piece of media content INH*(Qᵢ) in the vehicle.

The term “media content INH” is presently understood to mean, in particular music, a video or a film. Currently, various media sources Qᵢ, in particular streaming service providers (e.g. Spotify, Amazon Music, Apple Music, YouTube, etc.) , offer such media content INH for on-the-go access, with i=1, 2, . . . , I and I:=total number of the media sources Qᵢ. The media content INH(Qᵢ) offered differs from media source Qᵢ₌₁ to media source Q_{i≠1}. “INH(Qᵢ)” denotes media content that can be provided by the media source (media source) Qᵢ. “INH*(Qᵢ)” denotes media content INH*(Qᵢ) of the media source Qᵢ determined by the language model LM.

The term “energy state EZ(t) of the user” is presently understood to mean a psychological and/or physiological state of the user. Advantageously, a high level of alertness, a high degree of concentration, a high activity level, irritability, high stress, high heart rate, high pulse, etc., are associated with a high energy state EZ(t), whereas a low level of alertness, a low degree of concentration, a low activity level, being relaxed, low heart rate, low pulse, etc., are associated with a low energy state EZ(t).

The measured variables MGₘ(t) are recorded to determine therefrom the current energy state EZ(t) of the user. The measured variables MGₘ(t) advantageously include one or more parameters from the following non-exhaustive list:
movements of the user (e.g. steering wheel movements),
eye movements,
heart rate,
breathing rate,
blood pressure,
body temperature,
oxygen saturation,
blood sugar level.

Advantageously, the user's movements are recorded by means of optical sensors and/or haptic sensors, e.g., in seats. Eye movements are advantageously recorded by means of optical sensors. The cited vital parameters can be recorded by means of appropriately configured smart watches, for example.

Advantageously, the current energy state EZ(t) of the user is determined from the measured variables MGₘ(t) by means of a specified function f: EZ(t)=f(MGₘ(t)) or by means of a specified mathematical model MOD: EZ(t)=MOD(MGₘ(t)).

The term “target energy state EZ_{SOLL} of the user” is presently understood as a specified psychological and/or physiological state of the user, which is defined by specified target measured variables MG_{m,SOLL}.

Advantageously, a target energy state EZ_{SOLL} is specified, which represents a positive mood of the user who at the same time is paying sufficient attention.

Advantageously, the target energy state EZ_{SOLL} is specified depending on a traffic situation VS anticipated on a route section lying ahead of the vehicle: EZ_{SOLL}=EZ_{SOLL}(VS).

The term “language model LM” presently denotes a model, i.e., a mathematical model that models the order of elements in a sequence (for example of letters or words in natural language texts, usually in the form of a stochastic process. Regarding the amounts of data language models LM process, a distinction can be made between large language models LLM and small language models SLM. In the present case, the language model LM can be a large language model LLM or a small language model SLM.

The language model LM is presently embodied and designed to determine media content INH*(Qᵢ) from media content INH(Qᵢ) that can be provided by the relevant media source Qᵢ based on the current energy state EZ(t) of the user, the target energy state EZ_{SOLL}, and the media content INH_{ALT}(Qᵢ) provided for the user in the past, the media content INH*(Qᵢ) in such a way that, when output in the vehicle, the media content INH*(Qᵢ) is used (is suitable) to change the current energy state EZ(t) of the user to the target energy state EZ_{SOLL}.

Advantageously, the language model LM is embodied and designed to also take speech input made by the user into account when the determining the media content INH*(Qᵢ). The speech input can be recorded in the vehicle, for example, by means of a microphone and provided to the language model LM. In this way, the user's current individual preferences in terms of selecting media content INH(Qᵢ) can be taken into account.

Advantageously, each of the media sources Qᵢ has an assigned application programming interface API(Qᵢ), wherein the language model LM is embodied and designed to communicate with the respective media source Qᵢ via the API(Qᵢ) of the latter. Therefore, in particular, it is possible to simply and reliably communicate/exchange data with different streaming services, which are known for offering a wide variety of application programming interfaces APIs with different scopes of operation.

Advantageously, each media source Qᵢ provides a number P of assigned attributes ATTₚ for the media content INH(Qᵢ) that it can provide, with p=1, 2, . . . , P and P≥1, wherein an energy level EL(INH(Qᵢ)) describing the respective media content INH(Qᵢ) can be derived from the attributes ATTₚ(INH(Qᵢ)), and wherein the language model LM analyses the respective attributes ATTₚ(INH(Qᵢ)) with regard to the energy level EL(INH(Qᵢ)) in order to determine the media content INH*(Qᵢ). The number P and the type of the respective attributes ATTₚ (which content the attributes ATTₚ have) of various media sources Qᵢ may differ.

If the language model LM has determined multiple pieces of media content INH*(Qᵢ), the multiple pieces of content INH*(Qᵢ) are retrieved and/or output in succession in random order.

Advantageously, the media content INH*(Qᵢ) determined from different media sources Qᵢ is checked for the presence of media content INH*(Qᵢ) that is identical in terms of content, wherein only the non-identical pieces of media content INH*(Qᵢ) are output.

A further aspect of the invention relates to a computer system having a data processing device, wherein the data processing device is embodied such that a method, as described above, is executed on the data processing device.

A further aspect of the invention relates to a digital storage medium with electronically readable control signals, wherein the control signals can interact with a programmable computer system so that a method, as described above, is executed.

A further aspect of the invention relates to a computer program product having program code saved on a machine-readable carrier for performing the method, as described above, when the program code is executed on a data processing device.

A further aspect of the invention relates to a computer program with program code for performing the method, as described above, when the program runs on a data processing device.

A further aspect of the invention relates to a system for providing and outputting media content INH for a user of a vehicle, comprising:
a measuring means for recording measured variables MGₘ(t) for determining a current energy state EZ(t) of the user, with t:=time and m=1, 2, . . . , M and M≥1;
a specifying means for specifying a target energy state EZ_{SOLL} for the user;
an analysis means for determining the media content INH_{ALT}(Qᵢ) provided for the user in the past by one or more media sources Qᵢ, with i=1, 2, . . . , I and I≥1;
a language model LM for determining media content INH*(Qᵢ) from content INH(Qᵢ) that can be provided by the relevant media source Qᵢ, wherein the language model LM is embodied and designed to determine, based on the current energy state EZ(t) of the user, the target energy state EZ_{SOLL} and the media content INH_{ALT}(Qᵢ) provided for the user in the past, the media content INH*(Qᵢ) in such a way that, when output in the vehicle, the media content INH*(Qᵢ) is used (is suitable) to change the current energy state EZ(t) of the user to the target energy state WZ_{SOLL};
a retrieval means for retrieving at least one of the determined pieces of media content INH*(Qᵢ) from the assigned media source Qᵢ and
an output means (e.g. HiFi system of the vehicle) for outputting the at least one retrieved piece of media content INH*(Qᵢ) in the vehicle.

The specifying means, the analysis means, the language model LM, and the retrieval means are advantageously realized in an APP (application software, application).

Advantageous refinements of the proposed system become apparent by transferring the refinements of the proposed method to the system in an appropriate and analogous manner.

Further advantages, features and details will become apparent from the following description, in which—where appropriate, with reference to the drawings—at least one exemplary embodiment is described in detail. Identical, similar and/or functionally identical parts have been given the same reference signs.

### BRIEF DESCRIPTION OF THE DRAWING FIGURES

In the drawings:

FIG. 1 shows a highly schematized flowchart of a proposed method, and

FIG. 2 a highly schematized design of a proposed system.

### DETAILED DESCRIPTION

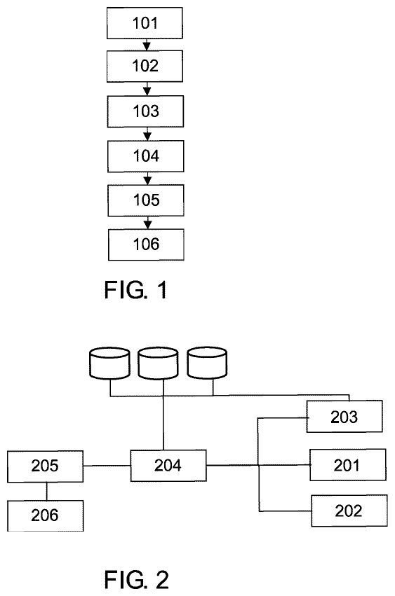

FIG. 1 shows a highly schematized flowchart of a proposed method, for providing and outputting music media content INH for a user of a vehicle. The method comprises the following steps.

In a step 101, measured variables MGₘ(t) are recorded for determining a current energy state EZ(t) of the user, with t:=time and m=1, 2, . . . , M and M≥1. The measured variables MGₘ(t) include eye movements and vital data of the user. The current energy state EZ(t) is determined by means of a specified mathematical model MOD: EZ(t)=MOD(MGₘ(t)) from the measured variables MGₘ(t).

In a step 102, a target energy state EZ_{SOLL} is specified for the user. In this example, the target energy state EZ_{SOLL} represents a psychological and physiological state in which the user is in a positive mood and at the same time is sufficiently awake and alert.

In a step 103, the music media content INH_{ALT}(Qᵢ) provided for the user in the past by one or more media sources Qᵢ is determined, with i=1, 2, . . . , I and I≥1. To this end, for example, a request can be made to the media sources Qᵢ for the user's retrieval history.

In a step 104, by means of a language model LM, music media content INH*(Qᵢ) is determined from music media content INH(Qᵢ) that can be provided by the relevant media source Qᵢ, wherein the language model LM determines, based on the current energy state EZ(t) of the user, the target energy state EZ_{SOLL}, and the music media content INH_{ALT}(Qᵢ) provided for the user in the past, the music media content INH*(Qᵢ) in such a way that, when output in the vehicle, the music media content INH*(Qᵢ) is used (is suitable) to change the current energy state EZ(t) of the user to the target energy state EZ_{SOLL}.

In the present case, the language model LM determines the music media content INH*(Qᵢ) (pieces of music) and provides the media source-specific identifiers ID(INH*(Qᵢ)) of the pieces of music.

In a step 105, at least one of the determined pieces of media content INH*(Qᵢ) is retrieved from the assigned media source Qᵢ on the basis of the media source-specific identifier ID(INH*(Qᵢ)).

In a step 106, the at least one retrieved piece of media content INH*(Qᵢ) is output in the vehicle by means of a vehicle HiFi system.

FIG. 2 shows a highly schematized design of a proposed system for providing and outputting media content INH for a user of a vehicle.

The system comprises measuring means 201 for recording measured variables MGₘ(t) for determining a current energy state EZ(t) of the user, with t:=time and m=1, 2, . . . , M and M≥1. To record vital data, the user wears a smart watch, which records measured variables such as heart rate, pulse, blood pressure, breathing rate, and oxygen saturation of the blood, analyzes these variables and provides them as measured variables MGₘ(t). Furthermore, the eye movements and body movements of the user are recorded by optical sensors, analyzed, and provided as measured variables MGₘ(t). based on the determined measured variables MGₘ(t), the measuring means 201 continues to determine the current energy state EZ(t) by means of a specified mathematical model MOD: EZ(t)=MOD(MGₘ(t)).

The system also comprises a specifying means 202 for specifying a target energy state EZ_{SOLL} for the user. The specifying means 202 is advantageously embodied and designed to specify, as target energy state EZ_{SOLL}, a psychological and physiological state in which the user is in a positive mood and at the same time is sufficiently awake and alert. This target energy state EZ_{SOLL} may be specified depending on the current energy state EZ(t) of the user and/or on an anticipated future situation in the vehicle or in traffic.

The system also comprises analysis means 203 for determining the media content INH_{ALT}(Qᵢ) provided for the user in the past by one or more media sources Qᵢ, with i=1, 2, . . . , I and I≥1. To this end, the analysis means 203 may access a list media content that has been output for this user to date, i.e., in the past.

The system also comprises a language model LM 204 for determining media content INH*(Qᵢ) from media content INH(Qᵢ) that can be provided by the relevant media source Qᵢ, wherein the language model LM is embodied and designed to determine, on the basis of the current energy state EZ(t) of the user, the target energy state EZ_{SOLL} and the media content INH_{ALT}(Qᵢ) provided for the user in the past, the media content INH*(Qᵢ) in such a way that, when output in the vehicle, the media content INH*(Qᵢ) is used (is suitable) to change the current energy state EZ(t) of the user to the target energy state WZ_{SOLL}.

The system also comprises a retrieval means 205 for retrieving at least one of the determined pieces of media content INH*(Qᵢ) from the assigned media source Qᵢ.

Lastly, the system comprises an output means 206 (e.g. a HiFi system) for outputting the at least one retrieved piece of media content INH*(Qᵢ) in the vehicle.

Although the invention has been illustrated and elucidated in detail by preferred exemplary embodiments, the invention is not restricted by the disclosed examples and a person skilled in the art can derive other variations therefrom, without departing from the scope of protection of the invention. It is therefore clear that a plurality of possible variations exists. It is likewise clear that embodiments mentioned by way of example actually only constitute examples that are in no way to be regarded as limiting the scope of protection, the possible uses or the configuration of the invention. Rather, the preceding description and the description of the figures enable a person skilled in the art to specifically implement the exemplary embodiments, wherein a person skilled in the art, with knowledge of the disclosed invention concept, can make numerous changes, for example with regard to the function or the arrangement of individual elements mentioned in an exemplary embodiment, without departing from the scope of protection which is defined by the claims and their legal equivalents, such as further clarifications in the description.

### List of reference designations

101-106 method steps
201 measuring means
202 specifying means
203 analysis means
204 language model LM
205 retrieval means
206 output means

1. A method for providing and outputting media content for a user of a vehicle, the method comprising:
recording measured variables for determining a current energy state of the user;
specifying a target energy state for the user;
determining media content previously provided for the user by one or more media sources;
determining, by a language model, particular media content from the determined previously provided media content providable by the one or more media sources that, when output in the vehicle, is used to change the current energy state of the user to the target energy state, wherein the particular media content is determined based on the current energy state of the user, the target energy state for the user, and the determined previously provided media content provided for the user;
retrieving at least one piece of media content from the particular media content from one of the one or more media sources; and
outputting the at least one retrieved piece of media content in the vehicle.

2. The method of claim 1, wherein the language model is a large language model or a small language model.

3. The method of claim 1, wherein the measured variables include at least one of:
movements of the user,
eye movements of the user,
heart rate of the user,
breathing rate of the user,
blood pressure of the user,
body temperature of the user,
oxygen saturation of the user, and
blood sugar level of the user.

4. The method of claim 1, wherein the current energy state of the user is determined from the measured variables using a specified function or a specified mathematical model.

5. The method of claim 1, wherein the target energy state is specified depending on a traffic situation anticipated on a route section lying ahead of the vehicle.

6. The method of claim 1, wherein each of the one or more media sources has an assigned application programming interface, wherein the language model communicates with the one or more media sources using the respectively assigned application programming interface.

7. The method of claim 1, wherein each of the one or more media sources provides a number of assigned attributes for media content that it can provide, and wherein the language model analyzes the respective attributes to determine the particular media content.

8. The method of claim 1, wherein when the language model determines the particular media content includes multiple pieces of media content, the multiple pieces of media content are retrieved and output in succession in random order.

9. The method of claim 1, wherein the media content determined from the media sources is checked for presence of identical media content, wherein only non-identical pieces of media content are output.

10. A system for providing and outputting media content for a user of a vehicle, the system comprising:
measuring means for recording measured variables for determining a current energy state of the user;
specifying means for specifying a target energy state for the user;
analysis means for determining media content previously provided for the user by one or more media sources;
a language model configured to determine particular media content from the determined previously provided media content providable by the one or more media sources that, when output in the vehicle, is used to change the current energy state of the user to the target energy state, wherein the particular media content is determined based on the current energy state of the user, the target energy state for the user, and the determined previously provided media content provided for the user;
retrieval means for retrieving at least one piece of media content from the particular media content from one of the one or more media sources; and
output means for outputting the at least one retrieved piece of media content in the vehicle.
